(19) United States
(12) Patent Application Publication
(10) Pub. No.: US 2008/0131685 A1
(43) Pub. Date: Jun. 5, 2008

(54) MICROCAPSULE-CONDUCTIVE PARTICLE COMPLEX, PREPARATION METHOD THEREOF AND ANISOTROPIC CONDUCTIVE ADHESIVE FILM USING THE SAME

(75) Inventors: Sang-Soo LEE, Seoul (KR); Jun-Kyung Kim, Seoul (KR); Hae-Eun Jung, Seoul (KR); Min Park, Seoul (KR); Soon-Ho Lim, Seoul (KR); Hyun-Jung Lee, Seoul (KR)

Correspondence Address: MORRISON & FOERSTER LLP, 12531 HIGH BLUFF DRIVE, SUITE 100, SAN DIEGO, CA, 92130-2040, US

(73) Assignee: Korea Institute of Science and Technology, Seoul (KR)

(21) Appl. No.: 11/939,538

(22) Filed: Nov. 13, 2007

(30) Foreign Application Priority Data
Nov. 16, 2006 (KR) 10-2006-0113534

(51) Int. Cl. B32B 5/16

(52) U.S. Cl. 428/327; 428/402.24

(57) ABSTRACT

The present invention relates to a microcapsule-conductive particle complex comprising a conductive particle consisting of conductive metallic particle or polymer particle coated on a surface with a conductive metallic layer; a microcapsule being adsorbed by the conductive particle or adsorbing the conductive particle, comprising a core and a shell, wherein the core contains organic compound which is a curing agent for a fast curing at a low temperature and the shell has a surface functional group with affinity for metal of the conductive metallic layer on its surface, a preparation method thereof and an anisotropic conductive film (ACF) using the same.

### CROSS-REFERENCE TO RELATED APPLICATIONS

The present application claims priority from Korean Application No. 10-2006-0113534 filed 16 Nov. 2006, which is hereby incorporated by reference herein in its entirety.

### TECHNICAL FIELD

The present invention relates to a microcapsule-conductive particle complex, a preparation method thereof and a low temperature fast curable anisotropic conductive film (ACF) using the same. More particularly, the present invention relates to a multi-functional microcapsule-conductive particle complex prepared by attaching microcapsules onto surfaces of conductive particles by physical adhesive force and chemical affinity, a preparation method thereof, and a low temperature fast curable ACF comprising the same. The low temperature fast curable ACF comprising microcapsule-conductive particle complex of the present invention is especially used for bonding of LCDs (Liquid Crystal Displays) or for bonding in a field such as packaging of electronic circuit devices.

### BACKGROUND ART

In recent times, a bonding (adhesion) technique using an ACF (Anisotropic Conductive Film) is essential in the field of an LCD packaging for bonding an LCD panel, a driver Integrated Circuit (IC) and a Printed Circuit Board (PCB) and has been developed progressively for the purpose of a fine-pitching based on a technical enhancement such as high resolution of a display, miniature of IC bump area and productivity improvement of a bonding process. For example, curing condition in 10 to 20 seconds at temperature over 150° C. for bonding, which is commonly being used, is changed to complete a curing reaction within 10 seconds at a low temperature below 100° C.

With respect to the conventional technology for bonding, it is suggested to provide functional group which can be cured at a low temperature to the conventional epoxy resin or methacrylate resin forming a matrix insulating resin layer of ACF. For changing the curing condition of the matrix insulating resin layer of the ACF into a fast curing at a low temperature, a type of the matrix insulating resin would be replaced with a curing resin with a structure of having flexibility even under a condition of a lower temperature and containing a functional group with much higher reactivity.

However, the method of prior art provides a relatively great change in molecular mobility with respect to heat because flexibility should be secured at a low temperature. Accordingly, physical property may greatly be lowered due to deterioration under a high temperature condition. Also, a great difference of thermal expansion coefficients between metallic components of electrodes constituting a bonding surface causes an interface short-circuited phenomenon under an operational condition which contraction and expansion are repeated by heat. As such, the related art method has a problem from a perspective of ensuring chemical-mechanical bonding reliability.

Instead of using the related art curing agent, in case of using a curing agent with a high reactivity for a fast curing at a low temperature, the curing agent being capable of showing a curing reaction within 10 seconds at a low temperature less than 100° C., the curing reaction is generated even while forming an ACF and keeping products. As a result, during a mounting operation, an adhesive force may not be applied and an electrical connection state can not be maintained.

### DISCLOSURE OF THE INVENTION

In order to solve those problems simultaneously, a curing agent is dispersed in a resin composition comprising the related art ACF insulating film to fast cure the resin composition at a low temperature, wherein the resin composition should be restricted from being directly contacted with the curing agent so as to enable reaction between the curing agent and the resin composition only during a bonding process.

To achieve this, the present invention provides microcapsules containing a curing agent therein, in which the curing agent is encapsulated to restrict a contact between an ACF resin composition and the curing agent. And then the curing agent is discharged out of the capsules when pressure is applied during a bonding process, such that the curing reaction of resin composition happens. The present invention provides also a multi-functional complex which is prepared by fixing the microcapsules containing the curing agent to surfaces of conductive particles using a physicochemical coherence as shown in FIG. 1, so as to be applied to the ACF.

The microcapsule-conductive particle complex of the present invention enables a selective adsorption of the microcapsules or a monolayer adsorption thereof, and is capable to modify the surfaces of the conductive particles. Also, it can effectively be utilized to the low temperature fast curable process of the complex materials such as ACF comprising microcapsule-conductive particle complex at a low temperature.

The present invention provides a microcapsule-conductive particle complex comprising a conductive particle and a microcapsule. The conductive particle is such as conductive metallic particle or polymer particle which is coated on a surface with a conductive metallic layer, and the microcapsule comprises a core and a shell encapsulating the core, wherein the core contains organic composition as a curing agent for a fast curing at a low temperature and the shell has a surface functional group with chemical affinity for metal of the conductive particle. In the present invention, microcapsule-conductive particle complex having a modified surface of high conductive metallic particle is provided by means of making the conductive particle adsorb or be adsorbed to the microcapsule. And the present invention additionally provides a method for preparing the microcapsule-conductive particle complex.

The present invention provides an originative ACF which can simultaneously implement mechanical durability, electrical reliability and low temperature fast curability in an conventional ACF technique by applying the microcapsule-conductive particle complex of the present invention to an ACF.

That is, the present invention provides a microcapsule-conductive particle complex, a preparation method thereof and a low temperature fast curable ACF using the same, in which the microcapsules can be adsorbed to the conductive particle selectively, these adsorption make the mounting process of ACF be cured quickly at a low temperature, the density of adsorption be controlled, the surface activity of the conductive particle be changed, and the particles be prevented from cohesion.

In the method of preparation for the microcapsule-conductive particle complex of the present invention, at first, it needs to be established a method for forming a spherical microcapsule containing a curing agent and forming a surface functional group on a surface of microcapsule, a surface functional group having a chemical affinity with the metal of a conductive particle. At second, it needs to be established an optimization technique such as an analysis of an adsorption condition between the microcapsule and the conductive particle, a shape analysis according to the adsorption condition and adsorption rate.

To achieve those aspects, the inventors created microcapsules containing a curing agent therein, applied a metal-affinitive functional group according to several methods, and established a preparation method of a conductive particle complex with microcapsules by an adsorption test with a selected conductive particle.

In particular, the inventors implemented the present invention by establish a preparation method capable of controlling and optimizing a shape of a microcapsule-conductive particle complex by systematically analyzing a content rate between a core material and shell material when preparing microcapsules with a core/shell structure, a change in a preparation condition of the capsule according to the content of a monomer containing a metal-affinitive functional group of the shell material, and a adsorption condition between the prepared microcapsule and the conductive particle (i.e., a reaction time, a type of solvent, a stirring speed, temperature, etc.).

### BRIEF DESCRIPTION OF THE DRAWINGS

FIG. 1 illustrates an assembly by the reaction of a selective hetero-adhesion between microcapsule-conductive particles according to the present invention; (1: conductive metallic layer, 2: polymer particle, 3: surface active material, 4: conductive metallic particle, 5: microcapsule, 6: surface functional group).

FIG. 2 is a mimetic diagram illustrating a discharge of an organic compound as a curing agent for a fast curing at a low temperature out of microcapsules by a bonding pressure and a curing reaction thereby in an ACF (Anisotropic Conductive Film) according to the present invention.

FIG. 3 is an electron microscopic picture of a microcapsule used in the present invention.

FIG. 4 is an electron microscopic picture of a microcapsule-conductive particle complex according to the present invention.

FIG. 5 is a graph illustrating changes in zeta potentials of microcapsules according to pH changes, and changes in levels of adsorption onto surfaces of conductive particles according to the changes in the zeta potentials.

### MODES FOR CARRYING OUT THE PREFERRED EMBODIMENTS

Hereinafter, the present invention is described in more detail.

First, sequential description will be given of a microcapsule-conductive particle complex, a preparation method thereof, and a low temperature fast curable anisotropic conductive film (ACF) using the microcapsule-conductive particle complex according to the present invention.

The microcapsule-conductive particle complex according to the present invention comprises (1) a conductive particle such as conductive metallic particle or a polymer particle coated on a surface with a conductive metallic layer, and (2) a microcapsule comprises a core and a shell encapsulating the core, wherein the core contains organic compound as a low temperature fast curable curing agent, and the shell has a surface functional group with affinity for metal of the conductive particle. In this point, the microcapsule-conductive particle complex is formed by adsorbing the microcapsule to the conductive particle or vice versa.

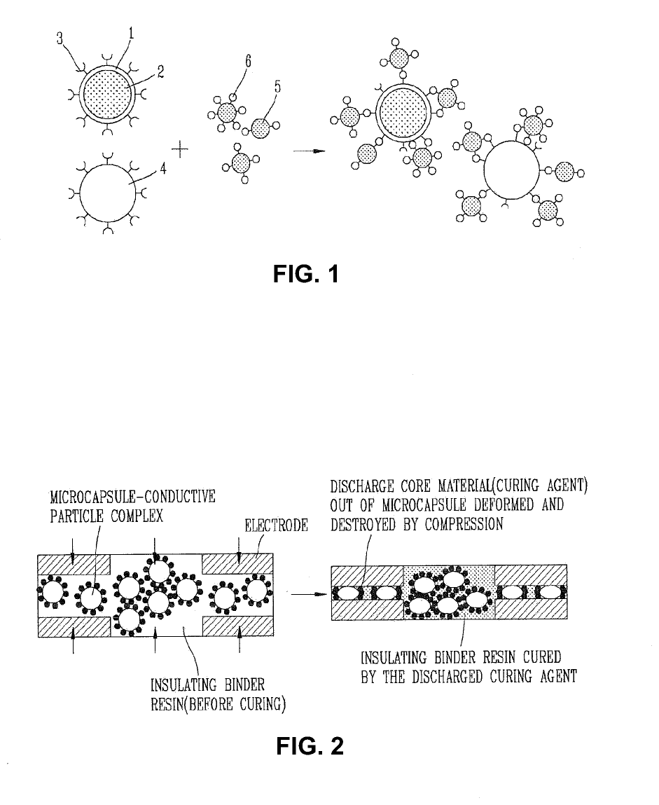

The microcapsule-conductive particle complex of the present invention will now be explained with reference to FIGS. 1, 3 and 4.

FIG. 1 illustrates the process of forming the microcapsule-conductive particles by selective hetero-adhesion between the microcapsules 5 and the conductive particles 2, 4 having surface active materials 3, wherein the microcapsule-conductive particle complexes of the present invention corresponds to those at the right side of an arrow.

The complex may have a structure in which a conductive metallic particle 4 and at least one of the microcapsules 5 having the surface functional group 6 are adhered. Another complex of the present invention may have a structure in which a polymer particle 2 coated on a surface with a conductive metallic layer 1 and the microcapsules 5 having the surface functional group 6 are adhered.

Here, as the conductive metallic particle 4, may be used gold, silver, copper, nickel, and the like. As the conductive metallic film 1 coated on the surface of the polymer particle 2, may also be used the gold, silver, copper, nickel, and the like. The conductive particle that the polymer particle 2 coated with the conductive metallic layer 1 can be formed by those skilled in the art, and in one embodiment of the present invention, a conductive particle that a polystyrene particle coated with gold or nickel/gold is used, the conductive particle having a diameter of 1 to 5 μm

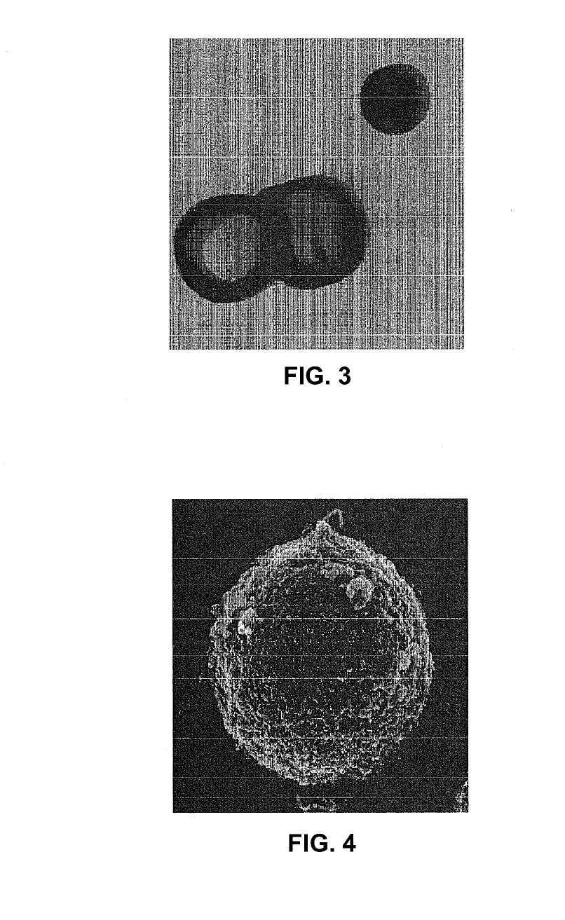

Microcapsules having a surface functional group are described with reference to FIGS. 3 and 4. Here, although not shown in FIGS. 3 and 4, the surface functional group may be carboxyl group, ester group, amide group, imide group, or anhydride group.

FIG. 3 illustrates a picture of a microcapsule constituting a complex of the present invention, the picture being captured using a transmission electron microscope.

A core of the microcapsule contains an organic compound as a curing agent for a fast curing at a low temperature (referred to as ‘low temperature fast curable curing agent’). The core of the microcapsule may contain one or more curing agents selected from the group consisting of imidazole derivatives such as 2-methylimidazole, 2-ethyl-4-methylimidazole, 1-cyanoethyl-2-undecylimidazolium trimellitate, epoxy-imidazole adduct, tertiary amine derivatives such as m-xylene diamine, methane diamine, N-aminoethyl piperazine and hydrophobic epoxy adduct. However, the curing agents may not be limited to those types.

A shell of the microcapsule may be made of a polymer resin which is thermoplastic vinyl polymers such as polystyrene, polyacrylate, acryl-styrene copolymer, or acrylonitrile-styrene copolymer. Here, a polymer resin to be used may not be limited to particular types, but be cross-linked to ensure thermal stability.

The microcapsule comprising the core and the shell may preferably have a diameter of 100 to 500 nm, but not be limited thereto.

FIG. 4 illustrates a picture of a microcapsule-conductive particle complex according to the present invention, the picture captured with a transmission electron microscope. FIG. 4 shows that the microcapsules are adsorbed onto the surface of the conductive particle. The adsorption is implemented by a van der Waals force, an electrostatic interaction or a chemical bonding.

Now, a method for preparing a microcapsule-conductive particle complex according to the present invention will be described with reference to FIG. 1.

The method for preparing the microcapsule-conductive particle complex may comprise two steps as follows,

(1) preparing a microcapsule comprising a core and a shell, wherein the core contains organic compound which is a low temperature fast curable curing agent and the shell has a surface functional group with affinity for metal of the conductive metallic layer on its surface; and

(2) adsorbing conductive particle onto the microcapsule, conductive particle consisting of conductive metallic particle or polymer particle coated on a surface with a conductive metallic layer.

Each step will now be described in detail.

### 1. Preparation Method of Microcapsule

At a first step, a mono-disperse microcapsule is prepared.

In the present invention, a microcapsule comprising a core/shell structure with a size of several tens to several hundreds nanometers by a miniemulsion polymerization using ultrasound is prepared.

In more detail, the preparation method of the microcapsule includes:

(A) forming micelle by adding surfactant into deionized water;

(B) introducing a mixture of monomer, a crosslinking agent, a liposoluble initiator and a core material into the deionized water by adding and stirring the monomer, the crosslinking agent, the fatsoluble initiator and the core material into the deionized water;

(C) forming a mini droplet using ultrasound;

(D) polymerizing the resultant by heat; and

(E) washing a residue monomer out of the resultant and drying the resultant.

The surfactant at the step (A) is used to form the micelle which acts as a nano reactor. For the surfactant, one or more of anionic emulsifier, cationic emulsifier and nonionic emulsifier can be used. In more detail, one or more surfactants can be selected from a group consisting of an anionic emulsifier such as sulfonates, carboxylic acids, succinates, sulfosuccinates and metallic salts thereof (e.g., alkylbenzenesulfonic acid, sodium alkylbenzenesulfonate, alkylsulfonic acid, sodium alkylsulfonate, sodium polyoxyethylenenonylphenylethersulfonate, sodium stearate, sodium dodecylsulfate, sodium dodecylsuccinate or abietolic acid); a cationic emulsifier such as high amine halides, quaternary ammonium salts or alkylpyridinium salts; and a nonionic emulsifier such as polyvinylalcohol or polyoxyethylenenonylphenyl. However, the surfactant may not be limited to those emulfisiers. 0.1 to 0.5 volume % of the surfactant is used with respect to 100 volume % of the monomer.

At the step (B), the compositions of reacting components may be 0.5 to 15 volume % of a core material, 0.1 to 15 volume % of a crosslinking agent, and 0.05 to 5 volume % of a liposoluble initiator, with respect to 100 volume % of the monomer.

The monomers at the step (B), can be at least one monomer selected from a group consisting of vinyl-based monomer containing carboxylic acid such as acrylic acid, methylacrylic acid or methylmetacrylic acid, and styrene-based or acrylate-based vinyl monomers such as α-methylstyrene, p-methylstyrene, methylmethacrylate or methylacrylate. However, the monomer may not be limited thereto. The monomer is used to form the shell encapsulating the core. In order to make the shell have coherence with the conductive particle, the shell of the microcapsule should be polymerized into polymer containing carboxylic acid. Accordingly, the above mentioned monomers are used.

The crosslinking agent for increasing chemical resistance and durability of the polymerized microcapsules includes at least one kind of compound consisting of allylmethacrylate, ethyleneglycoldimethacrylate, ethyleneglycoldiacrylate, butanedioldiacrylate, butanedioldimethacrylate, neopentylglycoldimethacrylate, hexanedioldimethacrylate, trietyleneglycoldimethacrylate, tetraetyleneglycoldimethacrylate, trimethylolpropanetrimethacrylate, pentaerytritoltetramethacrylate and divinylbenzene can be used.

Azo-based initiators can be used as the liposoluble initiator.

The core material to be contained in the microcapsule, namely, the organic compound as the low temperature fast curable curing agent encapsulated by the shell, can be at least one selected from the group consisting of imidazole derivatives such as 2-methylimidazole, 2-ethyl-4-methylimidazole, 1-cyanoethyl-2-undecylimidazolium trimellitate, epoxy-imidazole adduct, tertiary amine derivatives such as m-xylene diamine, methane diamine, N-aminoethyl piperazine and hydrophobic epoxy adduct. However, the curing agents may not be limited to those types.

The ultrasound system used at the step (C), which is a horn type, may have 200 to 1000 W of an output capability. This ultrasound system is used for 10 to 300 seconds to form a mini droplet. In particular, an iced water bath is used to prevent an increase in temperature.

At the step (D), a polymerization reaction is proceeded in 50 to 80° C. for 2 to 8 hours under a nitrogen atmosphere preferably.

Then, the shell of the microcapsule is polymerized under this condition, and the shell is composed of copolymer vinyl-based polymers, such as polystyrene, polyethylene, acryl-styrene copolymer or acrylonitrile-styrene copolymer. Here, a polymer material to be used may not be limited to particular types.

At the step (B) water-soluble initiators can be used instead of the liposoluble initiators. If the water-soluble initiator is used at the step (B), the water-soluble initiator is added immediately before the step (D) other than at the step (B), to proceed to the step (D).

As the water-soluble initiator, may be one of potassium persulfate, ammonium persulfate, sodium persulfate, ammonium bisulfate or sodium bisulfate.

The residual monomers without being reacted at the step (E) are removed by the way of filtering through a semipermeable membrane, and then the resultant is washed using an organic solvent such as acetone or sodium bisulfate.

Afterwards, the resultant is then centrifuged several times with deionized water and is lyophilized.

The distribution of the mean particle diameter of the microcapsule is measured with a particle size analyzer.

To check introducing the surface functional group onto the microcapsule, infrared absorption spectroscopy, ultraviolet absorption spectroscopy, and/or differential scanning calorimetry (DSC) can be used.

As aforementioned, the detailed explanation has been provided for the method for preparing the spherical microcapsule according to the present invention. However, the present invention may not be limited to the above embodiments.

### 2. Method for Preparing Microcapsule-Conductive Particle Complex

A second step is to attach a microcapsule containing an organic compound as a low temperature fast curable curing agent onto the surface of the conductive particle physically and chemically.

The microcapsule-conductive particle complex of the present invention is obtained either by the adsorbing microcapsules with a small diameter onto the surface of the conductive particle with a great diameter, or by adsorbing the conductive particles with a small diameter onto the microcapsule with a great diameter.

In one implement of the present invention, the microcapsule having a strong affinity to the metal of the conductive particle due to containing carboxylic acid as a functional group and the conductive particle such as a conductive metallic particle or polymer particle coated with a conductive metallic layer is put into a reactor and stirred for over 4 hours at 25˜40° C. Here, adsorption levels of the microcapsules can be adjusted according to pH.

As the conductive metallic particle, may be used gold, silver, copper, nickel, and the like. As the conductive metallic layer coated on the surface of the polymer particle, may also be used the gold, silver, copper, nickel, and the like. The conductive particle that the polymer particle coated with the conductive metallic layer can be formed by those skilled in the art, and in one embodiment of the present invention, a conductive particle that a polystyrene particle coated with gold or nickel/gold is used, the conductive particle having a diameter of 1 to 5 μm

In order to remove a physical adsorption or adhesion between particles, the polymer components of the microcapsules are washed using a proper solvent for the polymer several times. The good solvent may be one of a typical organic solvent, for example, a linear hydrocarbon solvent, such as toluene, methyl ethyl ketone or hexane/heptane.

After drying the formed complex, a scanning electron microscope is used to check whether the microcapsules have been stably adsorbed onto the surface of the conductive particles or vice versa.

Each microcapsule can have a different capsule diameter and diameter distribution, which may not be limited thereto.

Next, a low temperature fast curable ACF (Anisotropic Conductive Film) using the microcapsule-conductive particle complex according to the present invention will be described with reference to FIG. 2.

FIG. 2 is a mimetic diagram illustrating a discharge of an organic compound which is a low temperature fast curable curing agent out of microcapsules by an applied bonding pressure and a curing reaction thereby in an ACF (Anisotropic Conductive Film) according to the present invention. The low temperature fast curable ACF is formed by dispersing the microcapsule-conductive particle complex into the insulating binder and a solvent, coating a release film with the resultant with a certain thickness, and then removing the solvent by drying the resultant. Therefore, the low temperature fast curable ACF is the shape of the microcapsule-conductive particle complex dispersed in an insulating binder resin.

The insulating binder resin is cured by the discharged curing agents, when the bonding pressure is applied to the insulating binder to pop the curing agent out of the shell (in FIG. 2, in a vertical direction). Accordingly, the microcapsules of the microcapsule-conductive particular complex, which is dispersed in the ACF of the present invention, are deformed and destroyed, such that the organic compound curing agent is discharged out of the shell and cures the insulating binder resin as shown in FIG. 2.

Here, as the insulating binder resin, one or more types of thermoplastic resin and thermosetting resin mixed with each other may be used. The thermoplastic resin may be one of styrene butadiene resin, ethylene vinyl resin, ester resin, silicon resin, phenoxy resin, acrylic resin, amide resin, acrylate resin or polyvinylbutyral resin. The thermosetting resin may be one of epoxy resin, phenol resin or melamine resin. The insulating binder resin may be also every modified resin of the resin above.

The solvent used in the insulating binder resin may be hexane, cyclohexane, heptane, octane, decane, trimethylpentane, methylisobutylketone, methylethylketone, ethylacetone, acetone, methylcellulose, butylcellulose, hexanediol, cyclohexanol, butanol, isopropanol, toluene, m-cresol, o-cresol, xylene, dichlorobenzene, ethylenechloride, methylacetate, ethylacetate or butylacetate.

Also, the thickness of the anisotropic conductive film (ACF) is preferably 1 to 100 μM

Regarding the content of the microcapsule-conductive particle complex of the present invention with respect to the insulating binder resin, 0.1 to 10 volume % of the complex is preferably used with respect to 100 volume % of the insulating binder resin.

Hereinafter, the method of the present invention will be described in more detail according to embodiments and comparisons. However, the following embodiments may not limit the scope of the present invention.

### FIRST EMBODIMENT

### Preparation of Microcapsules According to Molar Ratio Of Styrene to Acrylic Acid

0.03 g of sodium dodecylsulfate (SDS) as a surfactant was added to 30 g of deionized water and stirred at a room temperature at a speed of 300 rpm for 10 minutes, thereby forming micelle.

Afterwards, total 3 g of monomers (e.g., styrene and acrylic acid) were prepared such that a molar ratio of the styrene to the acrylic acid could be in the ranges of 1:0.05, 1:0.16 or 1:0.3. Then the divinylbenzene as equivalent quantity as 0.3 wt. % of monomer, 0.5 g of 2-methylimidazole and 70 mg of 2,2′-azobisisobutyronitrile (AIBN) are mixed and put into the reactor containing the monomer.

With respect to the monomer, 3 volume % of divinylbenzene as a crosslinking agent, 0.5 g of 2-methylimidazole as the low temperature fast curable curing agent to be contained in a microcapsule, and 70 mg of 2,2′-azobisisobutyronitrile (AIBN) as liposoluble initiator were mixed all together to be put into the reactor, and the mixed solution was stirred at a room temperature at a speed of 600 rpm for 1 hour.

Then, a horn-type ultrasound system supporting 500 W of an output capability was used for 120 seconds by 70% of the output capability of the system, thereby forming a small droplet. Here, an iced water bath was used to prevent an increase in temperature.

The resultant was heated and stirred at temperature of 68° C. at a stirring speed of 300 rpm for 2 hours under a nitrogen atmosphere, thereby preparing a microcapsule of the present invention.

Residual monomers which had not been reacted were removed from the resultant by a cellulose semipermeable membrane filtration. Thereafter, centrifugation and lyophilization were sequentially preformed for the resultant.

[Table 1] as follows shows sizes of microcapsules each prepared according to the molar ratios of the styrene to the acrylic acid each of which is the monomer used in the first embodiment. It could be noticed that even if the molar ratios of the styrene to the acrylic acid were changed, the sizes of the prepared microcapsules were almost uniformly distributed.

TABLE 1

| | Styrene:acrylic acid (molar ratio) | | |
|---|---|---|---|
| | 1:0.05 | 1:0.16 | 1:0.3 |
| Diameter of microcapsule (nm) | 139 | 140 | 138 |

By controlling to concentration of material for attaching a functional group such as acrylic acid, a surface density of the polymer particles adsorbed onto the conductive particles can be controlled. Also, selectivity can be supported for the levels of adsorption onto the metallic particles.

### SECOND EMBODIMENT

### Effect According to Content Ratio Between Shell Material and Core Material of Microcapsule

Total 3 g of monomers (e.g., styrene and acrylic acid) were used such that a molar ratio of the styrene to the acrylic acid could be in the range of 1:0.3. The microcapsules of the present invention were prepared under the same conditions as those in the first embodiment except that a weight ratio of the shell material to the core material (e.g., 2-methylimidazole) was in the ranges of 1:6, 1:3, 1:1, 3:1 or 6:1.

In order to check whether the core material had been discharged due to the destroy of the capsule, a microcapsule having washed and dried was positioned between two sheets of glasses and a certain pressure such as 0.2 to 4 mN was applied thereon. And then the resultant was analyzed by using a polarizing microscope and an electron microscope. The applied pressure at a time point when the capsule was destroyed was different according to the weight ratio of each core material.

As such, when changing the weight ratio between the shell material and the core material (e.g., 2-methylimidazole), a change did not greatly occur in preparing the microcapsules. However, when the content of the core material to the shell material exceeds the ratio of 1:1, it could be noticed that the thickness of the shell was decreased, which resulted in a great decrease in stability of the microcapsules.

On the other hand, when the content of the core material to the shell material was less than 6:1, it could be checked with the electron microscope that several particulate resultants were generated without having a core-shell structure.

Therefore, when preparing the microcapsules, it could be confirmed that the optimal content ratio of the shell material to the core material (e.g., 2-methylimidazole) was in the ranges of 1:1 to 6:1 as aforementioned.

In addition, it was confirmed with the polarizing microscope that the core material had been discharged from the microcapsule after the pressure applied. Also, it was confirmed with an infrared spectroscopy that the discharged core material was the 2-methylimidazole which was the inner core material.

### THIRD EMBODIMENT

### Effect of Crosslinking Agent

Polymer which had not been crosslinked in the first embodiment could be dissolved by a solvent, and thereby a crosslinking agent was introduced when preparing microcapsules. The microcapsules of the present invention were prepared under the same conditions as those in the first embodiment except for adding divinylbenzene as the crosslinking agent respectively by 0 wt. %, 1 wt. %, 2 wt. %, 3 wt. %, 4 wt. %, 5 wt. %, 8 wt. % and 10 wt. % based on the volume of the monomer, instead of adding the divinylbenzene as equivalent quantity as 3 wt. % of the monomer.

The crosslinking density of the polymer particle was increased according to the content of the crosslinking agent to thus increase solvent resistance. When the content of the crosslinking agent was less than 1 volume %, the microcapsules were dissolved in the solvent such as THF, cyclohexane, and the like. When the content of the crosslinking agent was 2 to 3 volume %, the microcapsules were partially melted in the solvent. Also, when the content of the crosslinking agent was more than 4 volume %, the spherical microcapsules were maintained in their shape.

### 4 to 7 EMBODIMENTS

### Effect of Adsorption Method and Conditions (pH, Reaction Time, Stirring Speed, Temperature)

In order to optimize a condition for adsorption between the microcapsule prepared by a mini emulsion polymerization and gold-coated polymer as a conductive particle, NaOH and HCl were put into 1 g of latex (10 volume % of solid content), in which the microcapsules were dispersed and stabilized, to adjust pH. Thereafter, 0.05 g of conductive particle was added into the resultant and stirred by a vortex mixer, thereby physicochemically adsorbing the microcapsules onto the surface of the conductive particle.

While mixing two particles in the solvent of the first embodiment, pH was changed into 1.5, 2, 4, 6, 7, 8, 10, 12 and 14, to analyze adsorption levels according to the pH changes (Fourth embodiment). Also, a mixing time was increased to 30, 60, 90, 120, 180, 240, 360, 480, 600, 720 and 840 minutes, to analyze an adsorption effect according to the reaction time (Fifth embodiment). The stirring speed while mixing the two particles was changed into 100 rpm, 200 rpm, 300 rpm, 400 rpm and 500 rpm, to analyze the adsorption levels (Sixth embodiment). Also, the adsorption temperature while mixing the two particles was changed into 25° C., 40° C. and 60° C., to analyze the adsorption levels (Seventh embodiment).

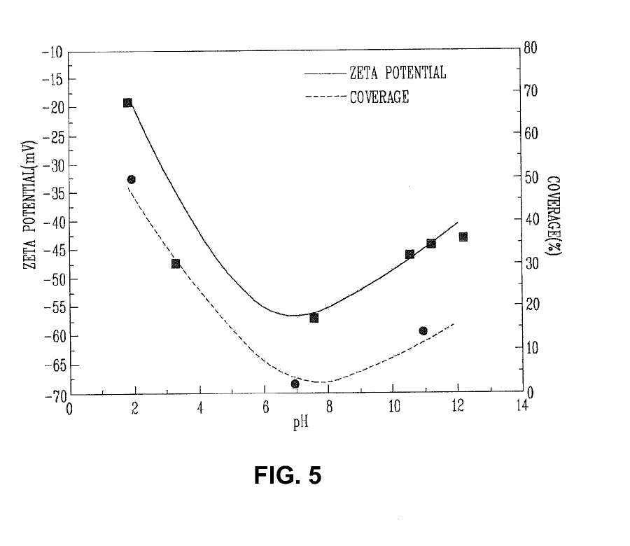

The adsorption levels of the surfaces of the microcapsules onto the surfaces of the conductive particles could be adjusted by changing electrostatic stability of dielectric microcapsules. Since the electrostatic stability of the dielectric microcapsules was changed according to the pH, the adsorption levels could be changed by adjusting medium pH (FIG. 5). FIG. 5 is a graph illustrating changes in zeta potentials of microcapsules according to pH changes (this result shows the electrostatic stability of the microcapsules) and changes in adsorption levels onto the surfaces of the conductive particles according to the changes in the zeta potentials. Thus, it was possible to prepare the microcapsule-conductive particle complex having different adsorption levels according to the pH.

The same complex was prepared when the reaction time is longer than 4 hours, when the stirring speed is faster than 100 rpm, and at all reaction temperature ranges.

### First Comparison Adsorption of Conductive Particles with Microcapsules According to Existence of Acrylic Acid

Under the preparation condition of the microcapsules in the first embodiment except for non-use of the acrylic acid, microcapsules were prepared. An adsorption test between the obtained resultant and the conductive particle was performed according to the fourth to seventh embodiments.

If the acrylic acid as a monomer was not used, the diameter of the formed microcapsule was increased up to 300 to 500 nm, and also a diameter distribution was greatly increased. When trying to adsorb these microcapsules onto the surface of the conductive particle, any microcapsule was not adsorbed onto the surface of the conductive particle. Accordingly, it could be recognized that a functional group should exist in the adsorption reaction of the microcapsules onto the surface of the conductive particle.

As such, by means of the result of the analysis from the several embodiments for the adsorption of a conductive particle and microcapsules having functional group, selective adsorption of microcapsules onto the conductive particle was achieved, wherein the microcapsules were able to discharge a core material when a certain pressure was applied.

Also, a complex preparation method capable of implementing an optimization of the adsorption was experimentally achieved.

### 8 AND 9 EMBODIMENTS

### Preparation of Anisotropic Conductive Film and Test for Transportation/Curing Characteristics

After mixing 100 volume % of epoxy resin (Kukdo chemical, YD-128) as an insulating binder resin and 100 volume % of toluene as a solvent, the microcapsule-conductive particle complex optimized in the 4 to 7 embodiments was added into the mixture such that the complex content could be 100,000/cm in the ACF. The resultant was appropriately stirred with a mixer to obtain a resin dispersion, which was then coated on a release film such that its thickness could be 5 μm after being dried. Afterwards, toluene was evaporated to obtain an ACF containing the microcapsule-conductive particle complex (Eighth embodiment).

The ACF containing the microcapsule-conductive particle complex was cut off into 5×10 mm, and then bonded on the center of a glass substrate (1 cm×2.5 cm) having a indium tin oxide (ITO) transparent electrode (0.2×20×0.02 mm). A glass substrate with the same ITO electrode was then bonded thereon such that the electrodes could be overlapped with each other by 90° C.

The bonded portion of the glass substrates was thermo-compressed under 1 to 4 conditions as follows. Then, resistance values between the electrodes were measured by a 4-probe method to obtain a ratio less than 5Ω. This test was performed with respect to 20 specimens according to each condition.

Condition 1: heat at temperature of 50° C. for 30 seconds under pressure of 20 N.

Condition 2: heat at temperature of 90° C. for 30 seconds under pressure of 20 N

Condition 3: heat at temperature of 90° C. for 15 seconds under pressure of 20 N

Condition 4: heat at temperature of 150° C. for 15 seconds under pressure of 20 N

Also, an adhesive force test was performed according to whether each specimen was horizontally moved by less than 2 mm when applying a shearing force of 10 N thereto. This test was performed with respect to 20 specimens according to each condition (Ninth embodiment)

TABLE 2

| | | Adhesive force test |
|---|---|---|
| Condition of thermo- | Current Test (less | (horizontal movement by |
| compression | than 5Ω) | less than 2 mm) |
| Condition 1 | 0 | 0 |
| Condition 2 | 19 | 18 |
| Condition 3 | 17 | 15 |
| Condition 4 | 20 | 20 |

As could be noticed in Table 2, ACF containing the microcapsule-conductive particle complex according to the present invention could be fast cured even at the temperature of less than 100° C., which was much lower than the temperature in a mounting condition of an conventional ACF. Also, its current characteristic was superior. Accordingly, it was available to obtain a bonding structure capable of being fast cured by using the ACF containing the microcapsule-conductive particle complex having the curing agent therein.

Each condition of the thermo-compression in the above embodiment has a different temperature and compression time. However, under the existing condition of the temperature of less than 150° C., the thermo-compression may not be limited to a specific condition.

### EFFECT OF THE INVENTION

In preparing the complex of the present invention using an adsorption of the conductive particle and the microcapsule, by changing a method for putting a functional group having a affinity with a metal onto microcapsules, a surface density of the functional group, a content ratio of shell/core material, affect of solvent resistance due to an addition of a crosslinking agent, adsorption conditions and the like, the systematical analysis was performed for the discharge phenomenon of the core material out of the microcapsules and the adsorption phenomenon of the microcapsules onto the surfaces of the conductive particles.

That is, in the present invention the microcapsule-conductive particles could be prepared by physicochemically bonding the microcapsules having the functional group with affinity with a metal at its surface onto conductive metallic particles or polymer particles coated with a conductive metallic layer. The selective adsorption were available according to the types of microcapsules, the surface adsorption density could be controlled. Also, the microcapsule-conductive particle complex could be applied to the surface modifying of the conductive particles or polymer particles, adhesion between particles could be effectively prevented.

Also, in the ACF obtained by dispersing the microcapsule-conductive particle complex prepared according to the present invention into an ACF insulating binder resin mixture to be coated on a release film, when applying pressure for mounting the ACF for a circuit construction, a core material, namely, an organic compound which is a curing agent for a fast curing at a low temperature fast curing were discharged. Accordingly, the ACF insulating binder resin film could be fast hardened at a temperature much less than that in mounting the existing ACF, namely, at a temperature less than 100° C. In addition, an anisotropic conductive adhesive film which can be fast hardened at a low temperature, which can correspond to a micropitch connection of electrons, could be obtained, so as to be conductive only in a direction to which a bonding pressure is applied (i.e., z-axial direction) and not to be conductive in x-axial and y-axial directions parallel to a bonded surface.

1. A microcapsule-conductive particle complex comprising:
a conductive particle consisting of conductive metallic particle or polymer particle coated on a surface with a conductive metallic layer;
a microcapsule being adsorbed by the conductive particle or adsorbing the conductive particle, comprising a core and a shell encapsulating the core, wherein the core contains organic composition as a low temperature fast curable curing agent and the shell has a surface functional group with affinity for metal of the conductive particle.

2. The complex of claim 1, wherein the metal of conductive metallic particle or the conductive metallic layer is one of gold, silver, copper and nickel.

3. The complex of claim 1, wherein the surface functional group is a carboxyl group or a derivative of the carboxyl group.

4. The complex of claim 1, wherein the shell of the microcapsule is styrene group, acrylate based thermoplastic vinyl polymer or thermoplastic vinyl copolymer thereof.

5. The complex of claim 4, wherein the shell of the microcapsule is a crosslinked polymer.

6. The complex of claim 1, wherein the organic compound which is the curing agent for the fast curing at the low temperature is at least one curing agents selected from the group of imidazole derivatives, tertiary amine derivatives, and hydrophobic epoxy adducts.

7. The complex of claim 1, wherein the microcapsule is adsorbed onto the conductive particle by one of van der Waals force, electrostatic interaction or chemical bonding.

8. A method for preparing a microcapsule-conductive particular complex comprising:
(1) preparing a microcapsule comprising a core and a shell, wherein the core contains organic compound which is a low temperature fast curable curing agent and the shell has a surface functional group with affinity for metal of the conductive metallic layer on its surface; and
(2) adsorbing conductive particle onto the microcapsule, conductive particle consisting of conductive metallic particle or polymer particle coated on a surface with a conductive metallic layer.

9. The method of claim 8, wherein the step (1) comprises:
(A) forming a micelle by adding a surfactant into deionized water;
(B) introducing a mixture of monomer, a crosslinking agent, a liposoluble initiator and a core material into the deionized water by adding and stirring the monomer, the crosslinking agent, the liposoluble initiator and the core material into the deionized water;
(C) forming a small droplet using ultrasound;
(D) polymerizing the resultant by heat; and
(E) washing a residue monomer out of the resultant and drying the resultant.

10. The method of claim 8, wherein the step (2) comprises:
dispersing the microcapsule having the surface functional group in a solvent;
stirring the resultant by adding the conductive particle therein; and
washing and drying the resultant using a washing solvent.

11. The method of claim 9, wherein the liposoluble initiator is not added at the step (B) but added immediately before the step (D).

12. The method of claim 9, wherein the monomer of the step (B) is at least one kind of monomer selected from the group of a vinyl monomer containing carboxylic acid, and a styrene or acrylate based vinyl monomer being able to be co-polymerized with the vinyl monomer.

13. The method of claim 9, wherein the organic compound which is the curing agent for the fast curing at the low temperature is at least one curing agents selected from the group of imidazole derivatives; tertiary amine derivatives; and hydrophobic epoxy adducts.

14. The method of claim 9, wherein the metal of conductive metallic particle or the conductive metallic layer is one of gold, silver, copper and nickel.

15. An anisotropic conductive adhesive film in which the microcapsule-conductive particular complex in claim 1 is dispersed in an insulating binder resin.

16. The film of claim 15, wherein the insulating binder resin is one resin selected from the group of styrene butadiene resin, ethylene vinyl resin, ester resin, silicon resin, phenoxy resin, acrylic resin, amide resin, acrylate resin, polyvinylbutyral resin, epoxy resin, phenol resin, melamine resin, and each modified resin thereof.
